(19) United States
(12) Patent Application Publication
(10) Pub. No.: US 2011/0310135 A1
(43) Pub. Date: Dec. 22, 2011

(54) LIQUID CRYSTAL DISPLAY CAPABLE OF REDUCING RESIDUAL IMAGES DURING A POWER-OFF PROCESS AND/OR A POWER-ON PROCESS OF THE LCD

(75) Inventor: Sha FENG, Shenzhen City (CN)

(73) Assignees: CHIMEI INNOLUX CORPORATION, Miao-Li County (TW); INNOCOM TECHNOLOGY (SHENZHEN) CO., LTD., Shenzhen City (CN)

(21) Appl. No.: 13/161,506

(22) Filed: Jun. 16, 2011

(30) Foreign Application Priority Data
Jun. 18, 2010 (CN) 201010203305.4

(51) Int. Cl. G09G 3/36; G09G 5/10

(52) U.S. Cl. 345/690; 345/90

(57) ABSTRACT

An LCD includes a liquid crystal panel having pixel electrodes, a timing controller for receiving image signals, a data driving circuit for receiving the timing control signals, the data signals and a predetermined voltage, converting the data signals into corresponding data voltages, and providing the data voltages to the pixel electrodes under control of the timing control signals, and a power circuit for providing a power voltage to the data driving circuit and the timing controller. The absolute value of a voltage difference between the common voltage and the predetermined voltage is a constant value. When the liquid crystal display is in a working state, the data driving circuit provides the data voltages to the pixel electrodes. When the liquid crystal display is in a power-off process, the data driving circuit provides the predetermined voltage to the pixel electrodes in order to display images corresponding to an identical gray scale.

### BACKGROUND

1. Technical Field

The present disclosure relates to liquid crystal displays (LCDs), and more particularly, to an LCD capable of reducing residual images during a power-off process and/or a power-on process of the LCD.

2. Description of Related Art

LCDs have the advantages of portability, low power consumption, low radiation, and have been widely used in various portable information products such as notebooks, personal digital assistants (PDAs), and video cameras.

An LCD generally includes a liquid crystal panel, a backlight module for emitting light beams to illuminate the liquid crystal panel, a data driving circuit for providing data voltages, and a common voltage generating circuit for providing a common voltage. The data voltages and the common voltage are provided to the liquid crystal panel to generate electric fields in the liquid crystal panel, to control transmission of light beams from the liquid crystal panel. During a power-on process of the LCD, a working voltage of the data driving circuit increases gradually to a normal value. A data latch unit of the data driving circuit randomly grabs image data before the working voltage of the data driving circuit reaches the normal value. The random image data are converted into random data voltages, and then the random data voltages are output to the liquid crystal panel. Accordingly, due to the random data voltages, upright bright lines may be displayed by the liquid crystal panel. That is, a residual image occurs during the power-on process.

In addition, during a power-off process of the LCD, residual charges within liquid crystal capacitors of the liquid crystal panel cannot be released rapidly, and thus the electric fields remain for an extended time period. During this extended time period, light beams may still transmit through the liquid crystal panel, and the residual image also occurs during the power-off process.

What is needed, therefore, is an LCD which can overcome the described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a partial circuit diagram of an LCD according to a first embodiment of the present disclosure, the LCD including a data driving circuit.

FIG. 2 is a block diagram of the data driving circuit of the LCD of FIG. 1, the data driving circuit including a voltage processing circuit.

FIG. 3 is a partial circuit diagram of a first exemplary voltage processing circuit of FIG. 2.

FIG. 4 is a partial circuit diagram of a second exemplary voltage processing circuit of FIG. 2.

FIG. 5 is a partial circuit diagram of a third exemplary voltage processing circuit of FIG. 2.

FIG. 6 is a partial circuit diagram of an LCD according to a second embodiment of the present disclosure, the LCD including a data driving circuit.

FIG. 7 is block diagram of the data driving circuit of the LCD of FIG. 6.

### DETAILED DESCRIPTION

Reference will now be made to the drawings to describe specific exemplary embodiments of the present disclosure in detail.

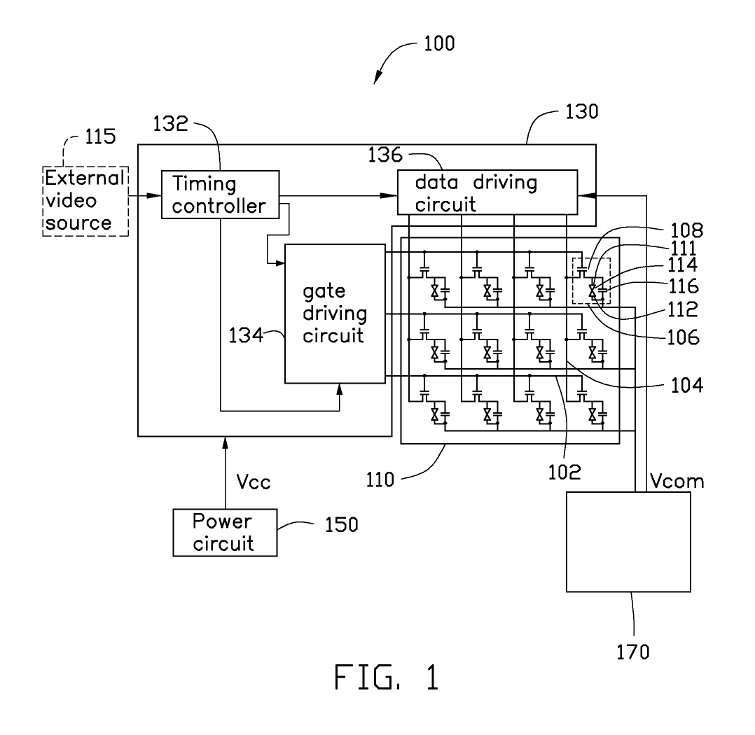

Referring to FIG. 1, an LCD 100 according to a first embodiment of the present disclosure is shown. In the first embodiment, the LCD 100 is a normally black LCD. The LCD 100 can selectively be in a working state and a power-off state. In the working state, the LCD 100 can display images corresponding to input data signals, and in the power-off state, the LCD 100 does not display any images. A power-on process exists during the state of the LCD switches from the power-off state to the working state, and a power-off process exists during the state of the LCD switching from the working state to the power-off state. [[I liked this paragraph, defines everything here, good job]]

The LCD 100 includes a liquid crystal panel 110, a driving circuit 130 for driving the liquid crystal panel 110, a power circuit 150 for providing a power voltage Vcc to the driving circuit 130, and a common voltage generating circuit 170 for providing a common voltage Vcom to the liquid crystal panel 110. In the illustrated embodiment, the power voltage Vcc may, for example, be 3.3V. The common voltage Vcom may, for example, be 5V.

The liquid crystal panel 110 includes a plurality of parallel gate lines 102, and a plurality of parallel data lines 104 intersecting the gate lines 102. The intersected gate lines 102 and the data lines 104 define an array of pixel units 106.

Each pixel unit 106 includes a thin film transistor (TFT) 108 disposed near an intersection of a corresponding one of the gate lines 102 and a corresponding one of the data lines 104, a liquid crystal capacitor 114, and a storage capacitor 116 connected with the liquid crystal capacitor 114 in parallel. The liquid crystal capacitor 114 includes a pixel electrode 111, a common electrode 112 opposite the pixel electrode 111, and a liquid crystal layer (not shown) sandwiched between the common electrode 112 and the pixel electrode 111. A gate electrode, a source electrode, and a drain electrode of the TFT 108 are connected to a corresponding gate line 102, a corresponding data line 104, and the pixel electrode 111 respectively. The common electrode 112 is connected to the common voltage generating circuit 170.

The driving circuit 130 includes a timing controller 132, a gate driving circuit 134, and a data driving circuit 136. The common voltage generating circuit 170 is further connected to the data driving circuit 136, and provides the common voltage Vcom to the data driving circuit 136. The timing controller 132 receives image data from an external video source 115, generates timing control signals and data signals (such as, RGB data) according to the received image data. The timing control signals are then provided to the data driving circuit 136 and the gate driving circuit 134, and the data signals are then provided to the data driving circuit 136. The gate driving circuit 134 provides a plurality of scanning signals to the gate lines 102 based on the received timing control signals. The data driving circuit 136 generates data voltages based on the received data signals and the timing control signals, and selectively outputs the data voltages or the common voltage Vcom. In detail, the data driving circuit 136 provides the data voltages to the pixel electrodes 111 when the LCD 100 is in the working state, and provides the common voltage Vcom to the pixel electrodes 111 when the LCD 100 is in the power-off process and/or the power-on process to eliminate the residual image phenomenon in the power-off process and/or the power-on process.

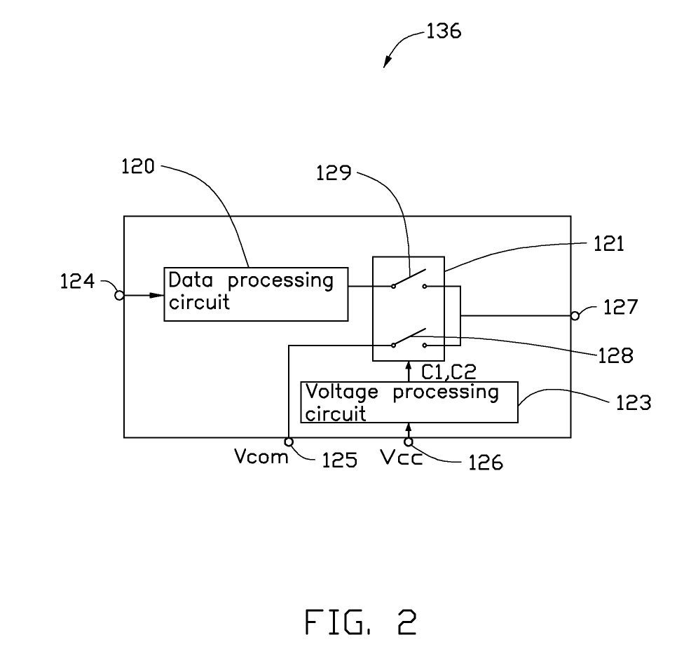

Referring to FIG. 2, a block diagram of the data driving circuit 136 is shown. The data driving circuit 136 includes a data processing circuit 120, a control circuit 121, a voltage processing circuit 123, a signal input end 124, a first voltage input end 125, a second voltage input end 126 and a voltage output end 127. The data processing circuit 120 is connected with the signal input end 124 and the control circuit 121. The voltage processing circuit 123 is connected with the second voltage input end 126 and the control circuit 121. The control circuit 121 is further connected with the first voltage input end 125 and the voltage output end 127. The control circuit 121 receives a first signal from the data processing circuit 120 and a second signal from the first voltage input end 125, and selectively outputs one of the first signal or second signal via the voltage output end 127 under the control of the voltage processing circuit 123. The control circuit 121 may include a first switching element 128 connected between the first voltage input end 125 and the voltage output end 127 for outputting the second signal to the voltage output end 127, and a second switching element 129 connected between the data processing circuit 120 and the voltage output end 127 for outputting the first signal to the voltage output end 127. The voltage processing circuit 123 controls both of the first and second switching elements 128 and 129.

For example, the data processing circuit 120 receives the timing control signals and data signals from the timing controller 132 via the signal input end 124, converts the data signals into the data voltages, and then provides the data voltages as the first signal to the second switching element 129 of the control circuit 121 according to the timing control signals. The common voltage Vcom from the common voltage generating circuit 170 acts as the second signal, and is provided to the first switching element 128 of the control circuit 121 via the first voltage input end 125. The power voltage Vcc from the power circuit 150 is provided to the voltage processing circuit 123. The voltage processing circuit 123 selectively outputs a first control signal C1 or a second control signal C2 to the control circuit 121 based on the value of the power voltage Vcc. The control circuit 121 controls one of the first and second switching elements 128, 129 to be on, and the other one of the first and second switching elements 128, 129 to be off according to the first or second control signals C1 or C2. For example, when the first control signal C1 is provided to the control circuit 121, the first switching element 128 is switched on, and the second switching element 129 is switched off. On the other hand, when the second control signal C2 is provided to the control circuit 121, the first switching element 128 is switched off, and the second switching element 129 is switched on. The first control signal C1 may be a low voltage signal, such as 0V, and the second control signal C2 may be a high voltage signal, such as 7V. Therefore, the data driving circuit 136 selectively outputs the data voltages or the common voltage Vcom via the voltage output end 127.

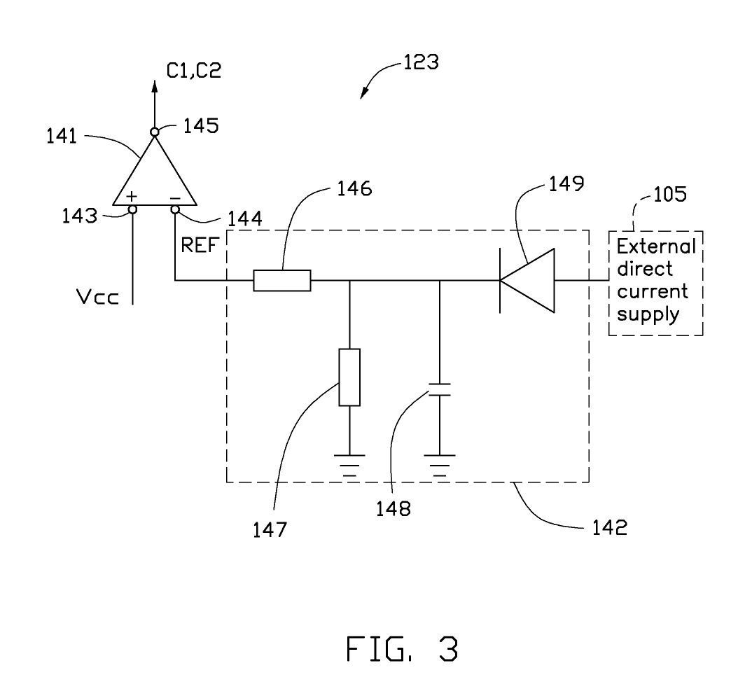

Referring to FIG. 3, a partial circuit diagram of a first exemplary voltage processing circuit 123 of FIG. 2 is shown, the first exemplary voltage processing circuit 123 is capable of providing the common voltage Vcom to the pixel electrodes 111 in the power-off process. The voltage processing circuit 123 includes a comparator 141 and a reference voltage generating circuit 142. The reference voltage generating circuit 142 is used for generating a reference voltage REF. The comparator 141 receives and compares the power voltage Vcc and the reference voltage REF. The reference voltage REF may be relative to the power voltage Vcc and variable according to the change of the power voltage Vcc. The changed speed of the power voltage Vcc received by the comparator is much faster than that of the reference voltage REF. The comparator 141 includes a first input end 143, a second input end 144 and an output end 145. The first input end 143 may be the second voltage input end 126 which connects to the power circuit 150 for receiving the power voltage Vcc. The second input end 144 connects to the reference voltage generating circuit 142 for receiving the reference voltage REF. The comparator 141 compares the power voltage Vcc and the reference voltage REF, and then correspondingly outputs the first control signal C1 or the second control signal C2 to the control circuit 121 based on the comparison result. The output end 145 connects to the control circuit 121 for outputting the first control signal C1 or the second control signal C2 to the control circuit 121.

When the LCD 100 is in the working state, both of the power voltage Vcc and the reference voltage REF may be constant voltages, and the power voltage Vcc may be greater than the reference voltage REF, the comparator 141 correspondingly outputs the second control signal C2 to the control circuit 121. Accordingly, the first switching element 128 is switched off, and the second switching element 129 is switched on. The data voltages from the data processing circuit 120 can thus be applied to the pixel electrodes 111 via the second switching element 129, the voltage output end 127 and the corresponding TFTs 108. In the illustrated embodiment, the reference voltage REF is preferably 80 percent of the power voltage Vcc when the LCD 100 is in the working state.

When the LCD 100 is in the power-off process, the power voltage Vcc decreases rapidly to be equivalent to or lower than the reference voltage REF, the comparator 141 correspondingly outputs the first control signal C1 to the control circuit 121. Accordingly, the first switching element 128 is switched on, and the second switching element 129 is switched off. The common voltage Vcom from the common voltage generating circuit 170 is thus applied to the plurality of pixel electrodes 111 via the first switching element 128, the voltage output end 127 and the TFTs 108, respectively. Therefore, no voltage difference is between the pixel electrode 111 and the common electrode 112 of the pixel unit 106. Thereby, the LCD 100 displays black images in the power-off process. The residual image phenomenon in the power-off process that might otherwise exist can be weakened or greatly reduced. Furthermore, an aging phenomenon of the liquid crystal molecules may be weakened or greatly reduced.

This paragraph gives an embodiment of a tangible circuit for accomplishing the relationship between the power voltage Vcc and the reference voltage REF. The reference voltage generating circuit 142 may include a first resistor 146, a second resistor 147, a capacitor 148 and a diode 149. An anode of the diode 149 may be connected to an external direct current supply 105, and a cathode of the diode 149 may be connected to the second input end 144 via the first resistor 146. The second resistor 147 and the capacitor 148 may be connected between the cathode of the diode 149 and ground in parallel. The capacitor 148 is configured to stabilize voltage. The diode 149 has a conduction function only along a signal direction, such as a forward direction, in order to prevent current flowing backwards. A direct current voltage may be provided by the external direct current supply 105 provided to the capacitor 148 and one end of the first resistor 146 via the diode 149. Correspondingly, the capacitor 148 starts to be charged, and a divided voltage may be generated at another end of the first resistor 146. The divided voltage, may be applied to the second input end 144 to act as the reference voltage REF. Therefore, the reference voltage REF decreases more slowly than that of the power voltage Vcc because of the discharge of the capacitor 148.

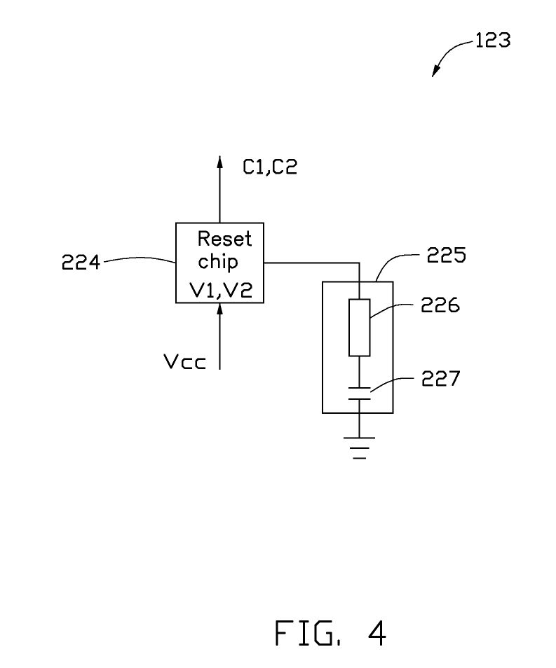

Referring to FIG. 4, a partial circuit diagram of a second exemplary voltage processing circuit 123 of FIG. 2 is shown. The LCD 100 with the second exemplary voltage processing circuit 123 is capable of providing the common voltage Vcom to the pixel electrodes 111 in the power-on and the power-off processes respectively. Therefore, the voltage processing circuit 123 shown in FIG. 4 cannot only weaken or greatly reduce the residual image phenomenon in the power-off process, but also further weaken or greatly reduce the residual image phenomenon in the power-on process.

The voltage processing circuit 123 includes a reset chip 224 and a time delay circuit 225. The reset chip 224 connects to the power circuit 150 and the control circuit 121. The reset chip 224 is configured to selectively output the first control signal C1 or the second control signal C2 to the control circuit 121 based on the value of the power voltage Vcc. The reset chip 224 stores a first reference value V1 and a second reference value V2. The reset chip 224 selects the first reference voltage value V1 as a reference standard when the LCD 100 is in the power-on process, and selects the second reference voltage value V2 as the reference standard when the LCD 100 is in the powered-off process. The first reference voltage value V1 is greater than the second reference voltage value V2. Further, the first and second reference voltage values V1, V2 are both less than the power voltage Vcc which is the constant voltage in the working state. The time delay circuit 225 is connected between the reset chip 224 and ground for making the reset chip 224 output the second control signal C2 instead of the first control signal C1 for a delay of a predetermined time when the power voltage Vcc reaches the first reference voltage value V1. In this embodiment, the reset chip 224 outputs the power voltage Vcc as the second control signal C2 to the control circuit 121.

For example, the time delay circuit 225 may include a resistor 226 and a capacitor 227. The resistor 226 and the capacitor 227 are connected between the reset chip 224 and ground in series. The delay of the predetermined time is accomplished by charging the capacitor 227 via the resistor 226 by the reset chip 224.

When the LCD 100 is in the powered-on process from the time that the power circuit 150 starts to output the power voltage Vcc to the reset chip 224 to the time that the data driving processing circuit 120 starts to output the generated data voltages based on the received data signals and the timing control signals from the timing controller 432 to the control circuit 121, the power voltage Vcc increases from 0V gradually. When the power voltage Vcc reaches the first reference value V1, the reset chip 224 starts to charge the capacitor 227 via the resistor 226. The data processing circuit 120 starts to output the data voltages to the control circuit 121 when the capacitor 227 is charged completely. During the time period after the power circuit 150 starts to output the power voltage Vcc to the reset chip 224 and before the capacitor 227 is charged completely, the reset chip 224 correspondingly outputs the first control signal C1 to the control circuit 121. Accordingly, the first switching element 128 is switched on, and the second switching element 129 is switched off. The common voltage Vcom from the common voltage generating circuit 170 is then applied to the plurality of pixel electrodes 111 via the first switching element 128, the voltage output end 127 and the TFTs 108, respectively. Therefore, no voltage difference is between the pixel electrode 111 and the common electrode 112 of the pixel unit 106. Thereby, the LCD 100 displays black images in the power-on process. The residual image phenomenon in the power-on process that might otherwise exist can be weakened or greatly reduced.

When the LCD 100 is in the working state, the reset chip 224 outputs the second control signal C2 instead of the first control signal C1 to the control circuit 121. Simultaneously, the data processing circuit 120 outputs the data voltages to the control circuit 121. The first switching element 128 is switched off, and the second switching element 129 is switched on under control of the second control signal C2. Accordingly, the data voltages are applied to the pixel electrodes 111 via the second switching element 129, the voltage output end 127 and the corresponding TFTs 108 respectively. In this embodiment, the time from the first control signal C1 output by the reset chip 224 to the second control signal C2 output by the reset chip 224 is predetermined to match with the time of the power-on process. Therefore, when the reset chip 224 outputs the second control signal C2, the LCD 100 simultaneously enters the working state.

When the LCD 100 is in the powered-off process, the power voltage Vcc decreases rapidly to be equivalent to or lower than the second reference voltage value V2, the reset chip 224 correspondingly outputs the first control signal C1 instead of the second control signal C2 to the control circuit 121. Accordingly, the first switching element 128 is switched on, and the second switching element 129 is switched off. The common voltage Vcom from the common voltage generating circuit 170 is thus applied to the plurality of pixel electrodes 111 via the first switching element 128, the voltage output end 127 and the TFTs 108, respectively. Therefore, no voltage difference is between the pixel electrode 111 and the common electrode 112 of the pixel unit 106. The LCD 100 displays black images in the power-off process. Thereby, the LCD 100 displays black images in the power-off process. The residual image phenomenon in the power-off process that might otherwise exist can be weakened or greatly reduced. Furthermore, an aging phenomenon of the liquid crystal molecules may be weakened or greatly reduced.

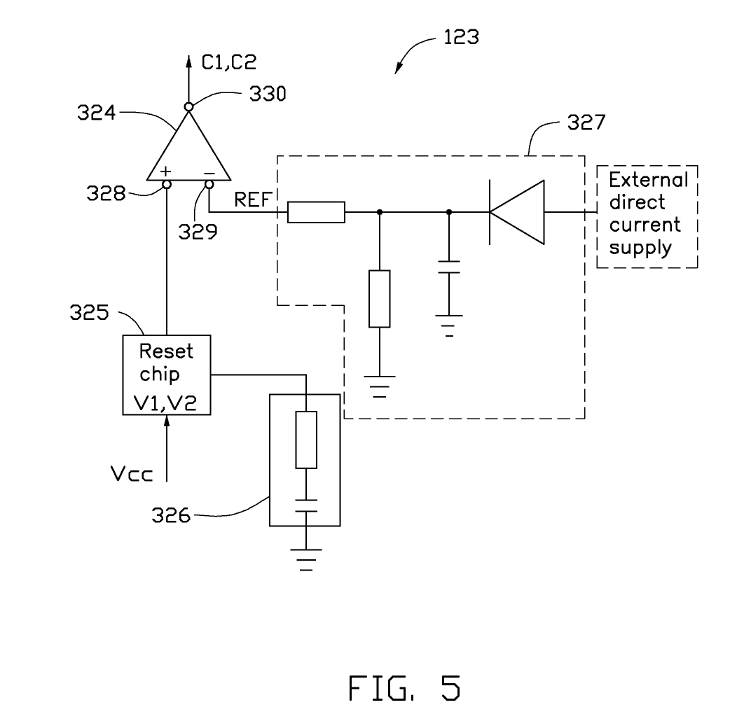

Referring to FIG. 5, a partial circuit diagram of a third exemplary voltage processing circuit 123 of FIG. 2 is shown. The voltage processing circuit 123 includes a comparator 324, a reset chip 325, a time delay circuit 326, and a reference voltage generating circuit 327. The comparator 324 includes a first input end 328, a second input end 329, and an output end 330. The first input end 328 connects to the power circuit 150 via the reset chip 325. The reference voltage generating circuit 327 is used for generating a reference voltage REF, and is connected to the second input end 329 to provide the reference voltage REF to the comparator 324. The output end 330 connects to the control circuit 121. The time delay circuit 326 is connected between the reset chip 325 and ground. The reset chip 325 is similar to the reset chip 224. The time delay circuit 326 is similar to the time delay circuit 225. The reference voltage generating circuit 327 is similar to the reference voltage generating circuit 142.

In detail, when the LCD is in the power-on process, the power voltage Vcc applied by the power circuit 150 increases from 0V, gradually. When the power voltage Vcc reaches the first reference value V1, the reset chip 224 starts to charge the capacitor 227 via the resistor 226. During the time period after the power circuit 150 starts to output the power voltage Vcc to the reset chip 325 and before the time delay circuit 225 is charged completely, the reset chip 325 correspondingly outputs a low voltage (such as, 0V) to the first input end 328. The value of the low voltage may be similar to that of the first control signal C1 provided by the reset ship 224. The low voltage is lower than the reference voltage REF output to the second input end 329 by the reference voltage generating circuit 327. At this time, the comparator 324 outputs the first control signal C1 to the control circuit 121 via the output end 330 according to a comparison result.

Accordingly, the first switching element 128 is switched on, and the second switching element 129 is switched off. The common voltage Vcom from the common voltage generating circuit 170 is thus applied to the plurality of pixel electrodes 111 via the first switching element 128, the voltage output end 127 and the corresponding TFTs 108, respectively. Therefore, no voltage difference is between the pixel electrode 111 and the common electrode 112 of the pixel unit 106. Thereby, the LCD 100 displays black images in the power-on process. The residual image phenomenon in the power-on process that might otherwise exist can be weakened or greatly reduced.

When the LCD 100 is in the working state, the reset chip 325 outputs the power voltage Vcc, to the first input end 328 because the time delay circuit 326 is charged completely. Both of the power voltage Vcc and the reference voltage REF may be constant voltages, and the power voltage Vcc may be greater than the reference voltage REF, the comparator 324 correspondingly outputs the second control signal C2 to the control circuit 121. Accordingly, the first switching element 128 is switched off, and the second switching element 129 is switched on. The data voltages from the data processing circuit 120 can thus be applied to the pixel electrodes 111 via the second switching element 129, the voltage output end 127 and the corresponding TFTs 108. In this embodiment, the time from the power voltage Vcc is output by the power circuit 150 to the data voltages that is generated based on the received data signals and the timing control signals from the timing controller 432 is output by the data processing circuit 120 is predetermined to match with the time of the power-on process. Therefore, when the data processing circuit 120 outputs the data voltages that are generated based on the received data signals and the timing control signals from the timing controller 432, the LCD 100 enters the working state, substantial simultaneously.

When the LCD 100 is in the powered-off process, the power voltage Vcc decreases rapidly to be equivalent to or lower than the second reference voltage value V2, the reset chip 224 correspondingly outputs the low voltage to the first input end 328. The comparator 324 compares the low voltage and the reference voltage REF, and correspondingly outputs the first control signal C1 instead of the second control signal C2 to the control circuit 121 via the output end 330. Accordingly, the first switching element 128 is switched on, and the second switching element 129 is switched off. The common voltage Vcom from the common voltage generating circuit 170 is thus applied to the plurality of pixel electrodes 111 via the first switching element 128, the voltage output end 127 and the corresponding TFTs 108, respectively. Therefore, no voltage difference is applied to the pixel units 106. Therefore, no voltage difference is between the pixel electrode 111 and the common electrode 112 of the pixel unit 106. The LCD 100 displays black images in the power-off process. Thereby, the LCD 100 displays black images in the power-off process. The residual image phenomenon in the power-off process that might otherwise exist can be weakened or greatly reduced. Furthermore, an aging phenomenon of the liquid crystal molecules may be weakened or greatly reduced.

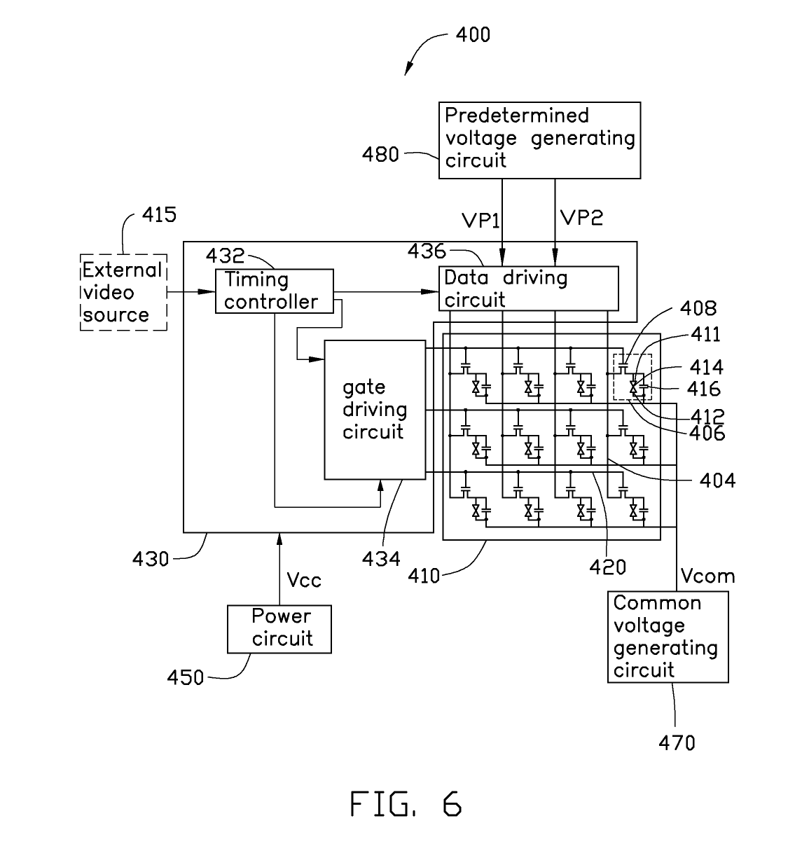

Referring to FIG. 6, FIG. 6 is an partial circuit diagram of an LCD according to a second embodiment of the present disclosure. The LCD 400 includes a liquid crystal panel 410, a driving circuit 430 for driving the liquid crystal panel 410, a power circuit 450 for providing a power voltage Vcc to the driving circuit 430, a common voltage generating circuit 470 for providing a common voltage Vcom to the liquid crystal panel 410, and a predetermined voltage generating circuit 480 for providing a first predetermined voltage Vp1 and a second predetermined voltage Vp2 to the driving circuit 430. The first predetermined voltage Vp1 may be lower than the second predetermined voltage Vp2, the second predetermined voltage Vp2 may be lower than the highest power voltage Vcc, and the highest power voltage Vcc may be lower than the common voltage Vcom. In the illustrated embodiment, the highest power voltage Vcc may, for example, be 3.3V. The common voltage Vcom may, for example, be 5V. The first predetermined voltage Vp1 can, for example, be 0V. The second predetermined voltage Vp2 can, for example, be 2V.

The liquid crystal panel 410 includes a plurality of parallel gate lines 402, and a plurality of parallel data lines 404 intersecting the gate lines 402. The intersected gate lines 402 and the data lines 404 define an array of pixel units 406.

Each pixel unit 406 includes a thin film transistor (TFT) 408 disposed near an intersection of a corresponding one of the gate lines 402 and a corresponding one of the data lines 404, a liquid crystal capacitor 414, and a storage capacitor 416 connected with the liquid crystal capacitor 414 in parallel. The liquid crystal capacitor 414 includes a pixel electrode 411, a common electrode 412 opposite the pixel electrode 411, and a liquid crystal layer (not shown) sandwiched therebetween. A gate electrode, a source electrode, and a drain electrode of the TFT 408 are connected to a corresponding gate line 402, a corresponding data line 404, and the pixel electrode 411 respectively. The common electrode 412 is connected to the common voltage generating circuit 470.

The driving circuit 430 includes a timing controller 432, a gate driving circuit 434, and a data driving circuit 436. The predetermined voltage generating circuit 480 is connected to the data driving circuit 436, and provides the first predetermined voltage Vp1 and the second predetermined voltage Vp2 to the data driving circuit 436. The timing controller 432 receives image data from an external video source 415, generates timing control signals and data signals (such as, RGB data) according to the received image data. The timing control signals are then provided to the data driving circuit 436 and the gate driving circuit 434, and the data signals are then provided to the data driving circuit 436. The gate driving circuit 434 provides a plurality of scanning signals to the gate lines 402 based on the received timing control signals. The data driving circuit 436 provides data voltages based on the received data signals and the timing control signals.

In the power-on process, the data driving circuit 136 provides the first predetermined voltage Vp1 to the pixel electrodes 111. In the working state, the data driving circuit 136 provides the data voltages to the pixel electrodes 111. In the power-off process, the data driving circuit 136 provides the second predetermined voltage Vp2 to the pixel electrodes 111.

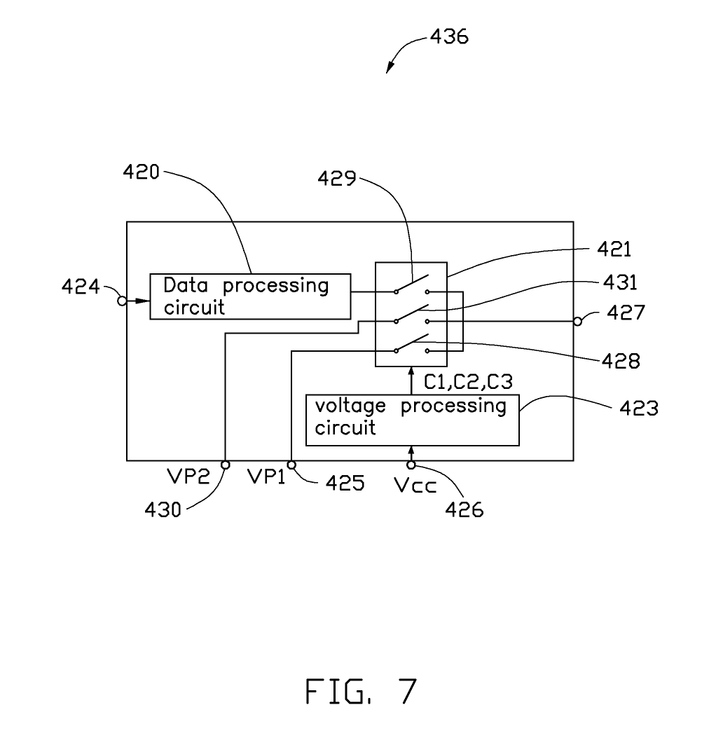

Referring to FIG. 7, a block diagram of the data driving circuit 436 is shown. The data driving circuit 436 includes a data processing circuit 420, a control circuit 421, a voltage processing circuit 423, a signal input end 424, a first voltage input end 425, a second voltage input end 426, a third voltage input end 430 and a voltage output end 427. The data processing circuit 420 is connected with the signal input end 424 and the control circuit 421. The voltage processing circuit 423 is connected with the second voltage input end 426 and the control circuit 421. The control circuit 421 is further connected with the first voltage input end 425, the third voltage input end 430 and the voltage output end 427. The control circuit 421 selectively outputs signals from the data processing circuit 420, the first voltage input end 425 or the third voltage input end 430 via the voltage output end 427 under the control of the voltage processing circuit 423. The control circuit 421 includes a first switching element 428 connected between the first voltage input end 425 and the voltage output end 427, a second switching element 429 connected between the data processing circuit 420 and the voltage output end 427, and a third switching element 431 connected between the third voltage input end 430 and the voltage output end 427. All of the first, second and third switching elements 428, 429 and 431 are controlled by the voltage processing circuit 423. In the second embodiment, the voltage processing circuit 423 may be similar to the voltage processing circuit 123.

In detail, the data processing circuit 420 receives the timing control signals and data signals from the timing controller 432 via the signal input end 424, converts the data signals into data voltages, and then provides the data voltages to the second switching element 429 of the control circuit 421 according to the timing control signals. The first predetermined voltage Vp1 from the predetermined voltage generating circuit 480 is provided to the first switching element 428 of the control circuit 421 via the first voltage input end 425. The second predetermined voltage Vp2 from the predetermined voltage generating circuit 480 is provided to the third switching element 431 of the control circuit 421 via the third voltage input end 430. The power voltage Vcc from the power circuit 450 is provided to the voltage processing circuit 423 via the second voltage input end 426. The voltage processing circuit 423 selectively outputs a first control signal C1, a second control signal C2 or a third control signal C3 to the control circuit 121 based on the value of the power voltage Vcc. The control circuit 421 controls one of the first, second and third switching elements 428, 429 and 431 is on, and the other two switching elements are off according to the first, second or third control signals C1, C2 or C3.

When the LCD 400 is in a power-on process to switch the state of the LCD 400 from a power-off state to a working state, the voltage processing circuit 423 provides the first control signal C1 to the control circuit 421, such that the first switching element 428 is switched on, and the second, third switching elements 429, 431 are switched off. Accordingly, the first predetermined voltage Vp1 from the predetermined voltage generating circuit 480 is applied to the plurality of pixel electrodes 411 via the first switching element 428, the voltage output end 427 and the TFTs 408, respectively. Therefore, a first constant voltage difference is applied to the pixel units 406 in the power-on process. Accordingly, the LCD 400 displays images corresponding to an identical gray scale. Therefore, the residual image phenomenon in the power-on process that might otherwise exist can be weakened or greatly reduced.

When the LCD 400 is in the working state, the voltage processing circuit 423 provides the second control signal C2 to the control circuit 421, such that the second switching element 429 is switched on, and the first, third switching elements 428, 431 are switched off. Accordingly, the data voltages from the data processing circuit 420 is applied to the plurality of pixel electrodes 411 via the second switching element 428, the voltage output end 427 and the TFTs 408, respectively. Accordingly, the LCD 400 displays corresponding images.

When the LCD 400 is in a power-off process to switch the LCD 400 from the working state to the power-off state, the voltage processing circuit 423 provides the third control signal C3 to the control circuit 421, such that the third switching element 431 is switched on, and the first, second switching elements 428, 429 are switched off.

Accordingly, the second predetermined voltage Vp2 from the predetermined voltage generating circuit 480 is applied to the plurality of pixel electrodes 411 via the third switching element 431, the voltage output end 427 and the TFTs 408, respectively. Therefore, a second constant voltage difference is applied to the pixel units 406. The LCD 400 displays images corresponding to another identical gray scale in the power-off process. Accordingly, the residual image phenomenon in the power-off process that might otherwise exist can be weakened or greatly reduced. The voltage processing circuit 423, for example, may be similar or even same as the voltage processing circuit 123.

It should be pointed out that in alternative embodiments, the LCD 100 further includes a printed circuit board (PCB) (not shown) connected to the liquid crystal panel 110. The reset chip 224, 325 and the time delay circuit 225, 326 may be able to disposed on the PCB instead of an all-in-one chip. The LCDs 100, 400 may be a normal white LCD instead of the normal black LCD. The first and second predetermined voltages Vp1, Vp2 may be any one of voltages which do not deteriorate liquid crystal molecules sandwiched within the liquid crystal panels 110, 410.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display, comprising:
a liquid crystal panel comprising a common electrode and a plurality of pixel electrodes;
a common voltage generating circuit configured to provide a common voltage to the common electrode;
a timing controller configured to receive image signals, and generate timing control signals and data signals according to the image signals;
a data driving circuit configured to receive the timing control signals, the data signals and a predetermined voltage, convert the data signals into corresponding data voltages, and provide the data voltages to the pixel electrodes under control of the timing control signals, the absolute value of a voltage difference between the common voltage and the predetermined voltage being a constant value; and
a power circuit configured to provide a power voltage to the data driving circuit and the timing controller;
wherein when the liquid crystal display is in a working state, the data driving circuit provides the data voltages to the pixel electrodes, when the liquid crystal display is in a power-off process to switch a state of the liquid crystal display from the working state to a power-off state, the data driving circuit provides the predetermined voltage to the pixel electrodes in order to display images corresponding to an identical gray scale.

2. The liquid crystal display of claim 1, wherein the common voltage is provided to the data driving circuit and acts as the predetermined voltage.

3. The liquid crystal display of claim 1, wherein the data driving circuit comprises a control circuit and a voltage processing circuit, the voltage processing circuit receives the power voltage and selectively outputs a first control signal and a second control signal to the control circuit according to a value of the power voltage, when the control circuit receives the first control signal from the voltage processing circuit, the control circuit correspondingly outputs the predetermined voltage to the pixel electrodes, when the control circuit receives the second control signal from the voltage processing circuit, the control circuit correspondingly outputs the data voltages to the pixel electrodes.

4. The liquid crystal display of claim 3, wherein the voltage processing circuit comprises a comparator and a reference voltage generating circuit configured for generating a reference voltage, the comparator receives the power voltage and the reference voltage, compares the power voltage and the reference voltage, and then selectively outputs the first control signal and the second control signal according to a comparison result, when the power voltage is equivalent to or less than the reference voltage, the comparator correspondingly outputs the first control signal to the controlling circuit, when the power voltage is greater than the reference voltage, the comparator correspondingly outputs the second control signal to the controlling circuit.

5. The liquid crystal display of claim 4, wherein the reference voltage generating circuit comprises a first resistor, a second resistor, a capacitor and a diode, an anode of the diode connected to an external direct current supply, and a cathode of the diode connected to an input end of the comparator via the first resistor, the second resistor and the capacitor connected between the cathode of the diode and ground in parallel.

6. The liquid crystal display of claim 5, wherein the control circuit comprises a first switching element and a second switching element, when the control circuit receives the first control signal from the voltage processing circuit, the first switching element is switched on, and the second switching element is switched off, the predetermined voltage is correspondingly output to the pixel electrodes via the first switching element, when the control circuit receives the second control signal from the voltage processing circuit, the first switching element is switched off, and the second switching element is switched on, the data voltages are correspondingly output to the pixel electrodes via the second switching element.

7. The liquid crystal display of claim 1, wherein when the liquid crystal display is in a power-on process to switch the state of the liquid crystal display from the power-off state to the working state, the data driving circuit provides the predetermined voltage to the pixel electrodes in order to display images corresponding to the identical gray scale.

8. The liquid crystal display of claim 7, wherein the data driving circuit comprises a control circuit and a voltage processing circuit, the voltage processing circuit receives the power voltage and selectively outputs a first control signal and a second control signal to the control circuit according to value of the power voltage, when the control circuit receives the first control signal from the voltage processing circuit, the control circuit correspondingly outputs the predetermined voltage to the pixel electrodes, when the control circuit receives the second control signal from the voltage processing circuit, the control circuit correspondingly outputs the data voltages to the pixel electrodes.

9. The liquid crystal display of claim 7, wherein the data driving circuit comprises a control circuit and a voltage processing circuit, the voltage processing circuit receives the power voltage and selectively outputs a first control signal, a second control signal and a third control signal to the control circuit according to value of the power voltage, when the liquid crystal display is in the power-on process, the voltage processing circuit outputs the first control signal to the controlling circuit, the control circuit correspondingly outputs the predetermined voltage to the pixel electrodes under control of the first control signal, when the liquid crystal display is in the working state, the voltage processing circuit outputs the second control signal to the controlling circuit, the control circuit correspondingly outputs the data voltages to the pixel electrodes under control of the second control signal, when the liquid crystal display is in the power-off process, the voltage processing circuit outputs the third control signal to the controlling circuit, the control circuit correspondingly outputs the predetermined voltage to the pixel electrodes under control of the third control signal.

10. The liquid crystal display of claim 8, wherein the voltage processing circuit comprises a reset chip storing a first reference voltage value and a time delay circuit connected between the reset chip and ground, the reset chip receives the power voltage from the power circuit, when the power voltage increases to the first reference voltage value, the power voltage starts to charge the time delay circuit, during the time period from the power circuit starts to output the power voltage to the reset chip to the time delay circuit is charged completely, the reset chip correspondingly outputs the first control signal to the controlling circuit, when the time delay circuit is charged completely, the reset chip correspondingly outputs the second control signal instead of the first control signal to the controlling circuit.

11. The liquid crystal display of claim 10, wherein the reset chip further stores a second reference voltage value, when the power voltage decreases to be equivalent to or lower than the second reference voltage value, the reset chip correspondingly outputs the first control signal instead of the second control signal to the controlling circuit.

12. The liquid crystal display of claim 10, wherein the time delay circuit comprises a capacitor connected between the reset chip and ground.

13. The liquid crystal display of claim 8, wherein the voltage processing circuit comprises a comparator, a reference voltage generating circuit for generating a reference voltage, a reset chip storing a first reference voltage value and a time delay circuit, the reference voltage generating circuit outputs the reference voltage to the comparator, the reset chip receives the power voltage from the power circuit, and then selectively outputs a first voltage lower than the reference voltage and a second voltage greater than the reference voltage to the comparator, when the power voltage increases to the first reference voltage value, the power voltage starts to charge the time delay circuit, during the time period from the power circuit starts to output the power voltage to the reset chip to the time delay circuit is charged completely, the reset chip correspondingly outputs the first voltage to the comparator, when the time delay circuit is charged completely, the reset chip correspondingly outputs the second voltage instead of the first voltage to the comparator, when the comparator receives the first voltage and the reference voltage, the comparator correspondingly outputs the first control signal to the controlling circuit, when the comparator receives the second voltage and the reference voltage, the comparator correspondingly outputs the second control signal to the controlling circuit.

14. The liquid crystal display of claim 13, wherein the reset chip further stores a second reference voltage value, when the power voltage decreases to be equivalent to or lower than the second reference voltage value, the reset chip correspondingly outputs the first voltage instead of the second voltage to the comparator, accordingly, the comparator outputs the second control signal to the controlling circuit.

15. The liquid crystal display of claim 13, wherein the reference voltage generating circuit comprises a first resistor, a second resistor, a capacitor and a diode, an anode of the diode connected to an external direct current supply, and a cathode of the diode connected to an input end of the comparator via the first resistor, the second resistor and the capacitor connected between the cathode of the diode and ground in parallel.

16. The liquid crystal display of claim 13, wherein the time delay circuit comprises a capacitor connected between the reset chip and ground.

17. A liquid crystal display, comprising:
a liquid crystal panel comprising a common electrode and a plurality of pixel electrodes;
a common voltage generating circuit configured to provide a common voltage to the common electrode;
a timing controller configured to receive image signals, and generate at least one timing control signals and data signals according to the image signals;
a data driving circuit configured to receive the timing control signals, the data signals and a predetermined voltage, convert the data signals into corresponding data voltages, and provide the data voltages to the pixel electrodes under control of the timing control signals, the absolute value of a voltage difference between the common voltage and the predetermined voltage being a constant value; and
a power circuit configured to provide a power voltage to the data driving circuit and the timing controller;
wherein when the liquid crystal display is in a power-on process to switch a state of the liquid crystal display from a power-off state to a working state, the data driving circuit provides the predetermined voltage to the plurality of the pixel electrodes, when the liquid crystal display is in the working state, the data driving circuit provides the data voltages to the plurality of the pixel electrodes.

18. The liquid crystal display of claim 17, wherein the common voltage is provided to the data driving circuit and acts as the predetermined voltage.

19. A liquid crystal display device, comprising:
a liquid crystal panel comprising a common electrode and a plurality of pixel electrodes;
a common voltage generating circuit configured to provide a common voltage to the common electrode;
a timing controller configured to receive image signals, and generate at least one timing control signals and data signals according to the image signals;
a data driving circuit configured to receive the timing control signals, the data signals, a first predetermined voltage and a second predetermined voltage, convert the data signals into corresponding data voltages, and provide the data voltages to the pixel electrodes under control of the timing control signals, the absolute value of a voltage difference between the common voltage and the first predetermined voltage being a constant value, the absolute value of a voltage difference between the common voltage and the second predetermined voltage being a constant value; and
a power circuit configured to provide a power voltage to the data driving circuit and the timing controller;
wherein when the liquid crystal display is in a power-on process to switch a state of the liquid crystal display from a power-off state to a working state, the data driving circuit provides the first predetermined voltage to the plurality of the pixel electrodes, when the liquid crystal display is in the working state, the data driving circuit provides the data voltages to the plurality of the pixel electrodes, when the liquid crystal display is in a power-off process to switch the state of the liquid crystal display from the working state to the power-off state, the data driving circuit provides the second predetermined voltage to the plurality of the pixel electrodes.

20. The liquid crystal display of claim 19, wherein the common voltage is provided to the data driving circuit and acts as the first and second predetermined voltages.
